(19) United States
(12) Patent Application Publication
(10) Pub. No.: US 2024/0184393 A1
(43) Pub. Date: Jun. 6, 2024

(54) METHOD AND ELECTRONIC DEVICE FOR DYNAMICALLY ADJUSTING SENSITIVITY OF TOUCHPAD

(71) Applicant: Acer Incorporated, New Taipei City (TW)

(72) Inventors: Sheng-Lin Chiu, New Taipei City (TW); An-Cheng Lee, New Taipei City (TW); En-Shin Chen, New Taipei City (TW); Ying-Shih Hung, New Taipei City (TW)

(73) Assignee: Acer Incorporated, New Taipei City (TW)

(21) Appl. No.: 18/327,862

(22) Filed: Jun. 1, 2023

(30) Foreign Application Priority Data
Dec. 5, 2022 (TW) 111146564

(51) Int. Cl. G06F 3/041; G06F 3/04855

(52) U.S. Cl. CPC G06F 3/0416; G06F 3/04855

(57) ABSTRACT

Disclosed are a method and an electronic device for dynamically adjusting sensitivity of a touchpad. System information of an electronic device is detected. A currently used window where a cursor stays is determined, a current use behavior of the currently used window is obtained, and a first touch sensitivity adjustment coefficient is accordingly determined. A window characteristic of the currently used window and a statistical characteristic of each window object in the currently used window are obtained, and a second touch sensitivity adjustment coefficient is determined based on the system information, the window characteristic of the currently used window, and the statistical characteristic of each window object. A specific touch sensitivity adjustment coefficient is determined based on the first and second touch sensitivity adjustment coefficients. Current touch sensitivity of the touchpad is adjusted to specific touch sensitivity based on the specific touch sensitivity adjustment coefficient.

### CROSS-REFERENCE TO RELATED APPLICATION

This application claims the priority benefit of Taiwanese application no. 111146564, filed on Dec. 5, 2022. The entirety of the above-mentioned patent application is hereby incorporated by reference herein and made a part of this specification.

### BACKGROUND

### Technical Field

The disclosure relates to technology of managing sensitivity of a touchpad. Particularly, the disclosure relates to a method and an electronic device for dynamically adjusting sensitivity of a touchpad.

### Description of Related Art

With the continuous development of notebook computers in the commercial market, demands for large-size screens is increasingly strong. In general, the notebook computer tends to have a built-in touchpad, which may be used for a user to control a cursor on the screen, for example.

However, the touchpad in some notebook computers with a relatively large size may occasionally be insensitive, causing lagging and excessively slowing during use of the touchpad to control movement of the cursor by the user.

### SUMMARY

The disclosure provides a method and an electronic device for dynamically adjusting sensitivity of a touchpad.

An embodiment of the disclosure provides a method for dynamically adjusting sensitivity of a touchpad. The method is adapted to an electronic device including a touchpad. The method includes the following. System information of the electronic device is detected. A currently used window where a cursor stays is determined in a user interface, a current use behavior of the currently used window is obtained, and a first touch sensitivity adjustment coefficient is accordingly determined. The currently used window includes at least one window object. A window characteristic of the currently used window and a statistical characteristic of each of the window object in the currently used window are obtained, and a second touch sensitivity adjustment coefficient is determined based on the system information, the window characteristic of the currently used window, and the statistical characteristic of each of the window object. A specific touch sensitivity adjustment coefficient is determined based on the first touch sensitivity adjustment coefficient and the second touch sensitivity adjustment coefficient. Current touch sensitivity of the touchpad is adjusted to specific touch sensitivity based on the specific touch sensitivity adjustment coefficient.

An embodiment of the disclosure provides an electronic device including a storage circuit and a processor. The storage circuit stores a programming code. The processor is coupled to the storage circuit and accesses the programming code to: detect a plurality of windows in a user interface, and obtain respective object properties of a plurality of window objects in each of the windows; detect system information of the electronic device; determine a currently used window where a cursor stays among the windows, obtain a current use behavior of the currently used window, and accordingly determine a first touch sensitivity adjustment coefficient; obtain a window characteristic of the currently used window and a statistical characteristic of each of the window objects in the currently used window, and determine a second touch sensitivity adjustment coefficient based on the system information, the window characteristic of the currently used window, and the statistical characteristic of each of the window objects; determine a specific touch sensitivity adjustment coefficient based on the first touch sensitivity adjustment coefficient and the second touch sensitivity adjustment coefficient; and adjust current touch sensitivity of the electronic device to specific touch sensitivity based on the specific touch sensitivity adjustment coefficient.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic device according to an embodiment of the disclosure.

FIG. 2 is a flowchart of a method for dynamically adjusting sensitivity of a touchpad according to an embodiment of the disclosure.

FIG. 3 is a flowchart of determining a first touch sensitivity adjustment coefficient according to an embodiment of the disclosure.

FIG. 4 is a flowchart of obtaining a window characteristic of a currently used window according to an embodiment of the disclosure.

FIG. 5 is a flowchart of determining a statistical characteristic of each window object in a currently used window according to an embodiment of the disclosure.

FIG. 6 is a schematic diagram of a Sigmoid function according to an embodiment of the disclosure.

### Description of the Embodiments

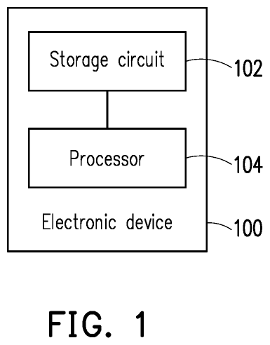

With reference to FIG. 1, FIG. 1 is a schematic diagram of an electronic device according to an embodiment of the disclosure. In different embodiments, an electronic device 100 is various modes of smart devices and/or computer devices (e.g., a notebook computers) including a touchpad, for example but may not be limited thereto.

In FIG. 1, the electronic device 100 includes a storage circuit 102 and a processor 104. The storage circuit 102 is any form of fixed or removable random access memory (RAM), read-only memory (ROM), flash memory, a hard disk drive, or other similar devices or a combination of these devices, for example, and may be configured to record a plurality of programming codes or modules.

The processor 104 is coupled to the storage circuit 102, and may be a general-purpose processor, a special-purpose processor, a conventional processor, a digital signal processor, a plurality of microprocessors, one or more microprocessors combined with a digital signal processor core, a controller, a microcontroller, an application specific integrated circuit (ASIC), a field programmable gate array (FPGA), any other form of an integrated circuit, a state machine, a processor based on Advanced RISC Machine (ARM), and the like.

In the embodiment of the disclosure, the processor 104 may access the modules and programming codes recorded in the storage circuit 102 to realize the method for dynamically adjusting sensitivity of a touchpad provided by the embodiment of the disclosure, details of which are described below.

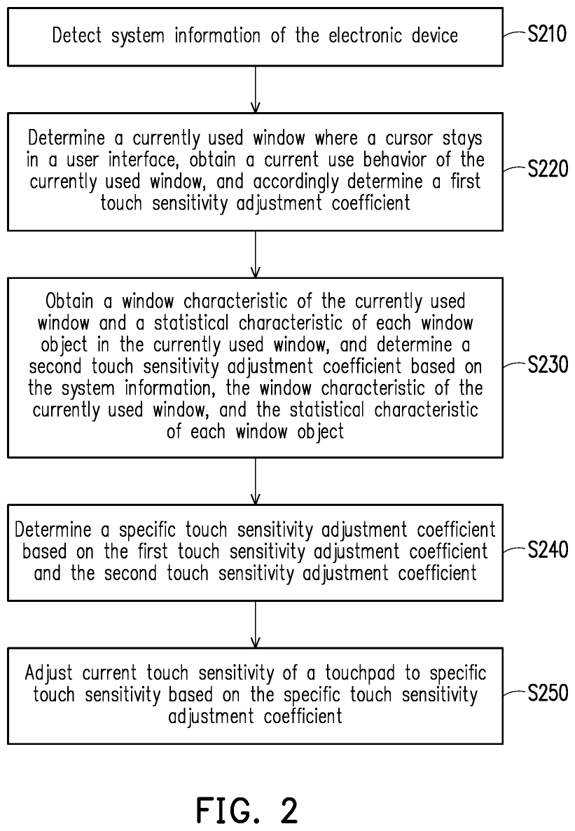

With reference to FIG. 2, FIG. 2 is a flowchart of a method for dynamically adjusting sensitivity of a touchpad according to an embodiment of the disclosure. In this embodiment, the method may be performed by the electronic device 100 in FIG. 1. Details of the steps in FIG. 2 accompanied with the elements shown in FIG. 1 will be described below.

First, in step S210, the processor 104 detects system information of the electronic device 100. In different embodiments, the system information includes at least one of a screen resolution, control information, a cursor position, a touch point position, and current touch sensitivity of the touchpad of the electronic device 100, for example.

In step S220, the processor 104 determines a currently used window where a cursor stays in a user interface, obtains a current use behavior of the currently used window, and accordingly determines a first touch sensitivity adjustment coefficient (hereinafter referred to as Sₗ).

In an embodiment, the user interface is a desktop of the electronic device 100, for example, and may include a plurality of windows. The processor 104 may determine the window controlled by the touchpad and/or the window where the mouse cursor currently stays to be the currently used windows, for example.

In an embodiment, the processor 104 may detect one or more window objects in each window in the user interface, and determine a property of each window object. In an embodiment, the property of a window object A include a position, a size, and a control type of the window object A, for example but may not be limited thereto.

In an embodiment, the window objects may be divided into two types: a clickable object and an unclickable object. The clickable object refers to a control mainly serving to receive a cursor click command of a user, for example but may not be limited to, a button, a toolbar, a checkbox, Combobox, DateTimePicker. The unclickable object refers to a control mainly serving to present information to a user, for example but may not be limited to, a label, PictureBox, ProgressBar, TextBox.

In different embodiments, for example, the processor 104 may use a corresponding utility program/application programming interface (API) to obtain the above-mentioned information according to the running operating system. For example, if the operating system of the electronic device 100 is Windows, the processor 104 may use a program/API named “Microsoft Inspect tool”, for example, to obtain the property of each window object in the user interface. If the operating system of the electronic device 100 is Chrome OS, the processor 104 may use a program/API named “Chrome DevTool”, for example, to obtain the property of each window object in the user interface. Nonetheless, the disclosure may not be limited thereto.

In addition, various parameters to be described in the following embodiments (including but not limited to various parameters with a subscript c) may also be obtained by the processor 104 using a corresponding utility program/API according to the running operating system.

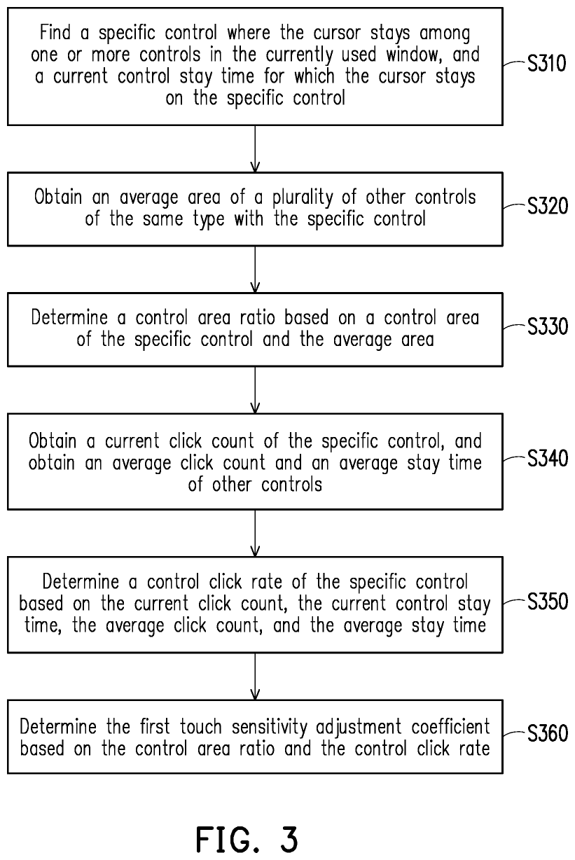

In an embodiment, the processor 104 may realize step S220 through the mechanism shown in FIG. 3, for example.

With reference to FIG. 3, FIG. 3 is a flowchart of determining a first touch sensitivity adjustment coefficient according to an embodiment of the disclosure. In step S310, the processor 104 may find a specific control where the cursor stays among one or more controls in the currently used window, and a current control stay time (hereinafter referred to as U) for which the cursor stays on the specific control.

In step S320, the processor 104 may obtain an average area (hereinafter referred to as Bᵣ) of a plurality of other controls of the same type with the specific control. For example, assuming that the specific control is a checkbox, the designer may collect areas of other controls that are also checkboxes on other electronic devices in advance, and take their average value as the average area (Bᵣ). For another example, assuming that the specific control is a button, the designer may collect areas of other controls that are also buttons on other electronic devices in advance, and take their average value as the average area (Bᵣ). Nonetheless, the disclosure may not be limited thereto.

In step S330, the processor 104 may determine a control area ratio (hereinafter referred to as B) based on a control area (hereinafter referred to as B_{c}) of the specific control and the average area (Bᵣ). In an embodiment, the control area ratio may be represented as “B=B_{c}/Bᵣ”, for example but may not be limited thereto.

In step S340, the processor 104 may obtain a current click count (hereinafter referred to as M) of the specific control, and obtain an average click count and an average stay time of other controls as mentioned above. For example, assuming that the specific control is a checkbox, the designer may collect click counts and stay times of other controls that are also checkboxes on other electronic devices in advance, and take the corresponding average values as the average click count and the average stay time. For another example, assuming that the specific control is a button, the designer may collect click counts and stay times of other controls that are also buttons on other electronic devices in advance, and take the corresponding average values as the average click count and the average stay time. Nonetheless, the disclosure may not be limited thereto.

In step S350, the processor 104 may determine a control click rate (hereinafter referred to as P) of the specific control based on the current click count (M), the current control stay time (U), the average click count, and the average stay time. In an embodiment, the processor 104 may divide the sum of the current click count (M) and the average click count by the sum of the current control stay time (U) and the average stay time to determine the control click rate (P) of the specific control, but may not be limited thereto.

In step S360, the processor 104 may determine the first touch sensitivity adjustment coefficient (Sₗ) based on the control area ratio (B) and the control click rate (P).

In an embodiment, the first touch sensitivity adjustment coefficient (Si) may be represented as:

Sₗ=(W_{B}*B+W_{P}*P⁻¹)/(W_{B}+W_{P}) Formula (1)

where W_{B} and W_{P} are a plurality of weights respectively corresponding to B and P. As can be seen from Formula (1), the first touch sensitivity adjustment coefficient (Si) is positively correlated with the control area ratio (B), and negatively correlated with the control click rate (P), but may not be limited thereto.

With reference to FIG. 2 again, in step S230, the processor 104 obtains a window characteristic of the currently used window and a statistical characteristic of each window object in the currently used window, and determines a second touch sensitivity adjustment coefficient (hereinafter referred to as S_{g}) based on the system information, the window characteristic of the currently used window, and the statistical characteristic of each window object.

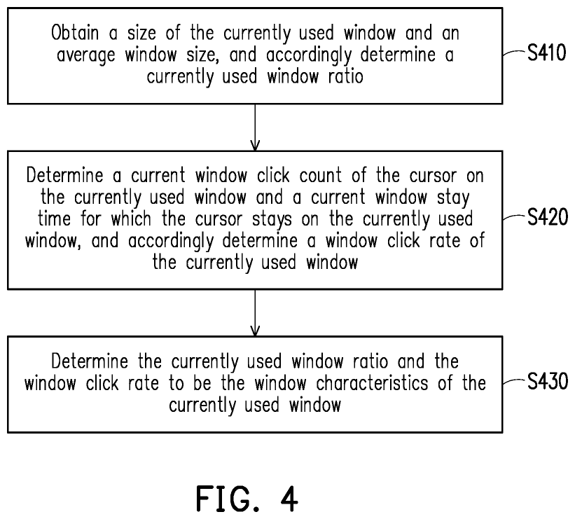

In an embodiment, the processor 104 may obtain the window characteristic of the currently used window through the mechanism shown in FIG. 4.

With reference to FIG. 4, FIG. 4 is a flowchart of obtaining a window characteristic of a currently used window according to an embodiment of the disclosure. In step S410, the processor 104 may obtain a size (hereinafter referred to as I_{c}) of the currently used window and an average window size (hereinafter referred to as Iᵣ), and accordingly determine a currently used window ratio (hereinafter referred to as I).

In this embodiment, the designer may collect sizes of other windows on other electronic devices in advance, and take their average value as the average window size (Iᵣ), but may not be limited thereto. In an embodiment, the currently used window ratio (I) may be represented as “I=I_{c}/Iᵣ”, but may not be limited thereto.

In step S420, the processor 104 may determine a current window click count (hereinafter referred to as K) of the cursor on the currently used window and a current window stay time (hereinafter referred to as T) for which the cursor stays on the currently used window, and accordingly determine a window click rate (hereinafter referred to as D) of the currently used window.

In an embodiment, the processor 104 may also obtain an average window click count and an average window stay time of other windows. For example, the designer may collect click counts and stay times of other windows on other electronic devices in advance, and take the corresponding average values as the average window click count and the average window stay time, but may not be limited thereto.

In an embodiment, the processor 104 may divide the sum of the current window click count (K) and the average window click count by the sum of the current window stay time (T) and the average window stay time to determine the window click rate (D) of the currently used window, but may not be limited thereto.

Next, in step S430, the processor 104 may determine the currently used window ratio (I) and the window click rate (D) to be the window characteristics of the currently used window.

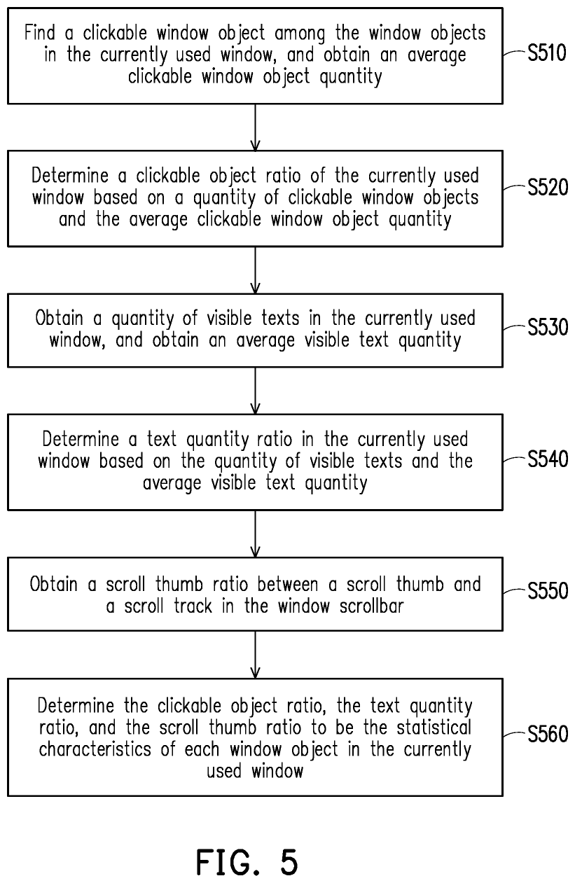

In an embodiment, the processor 104 may determine the statistical characteristic of each window object in the currently used window through the mechanism shown in FIG. 5, for example.

With reference to FIG. 5, FIG. 5 is a flowchart of determining a statistical characteristic of each window object in a currently used window according to an embodiment of the disclosure. In this embodiment, the currently used window may include a plurality of visible texts and a window scrollbar, but may not be limited thereto.

In step S510, the processor 104 may find a clickable window object among the window objects in the currently used window, and obtain an average clickable window object quantity (hereinafter referred to as Nᵣ).

In an embodiment, the designer may collect quantities of other clickable window objects on other electronic devices in advance, and take the corresponding average value as the average clickable window object quantity (Nᵣ), but may not be limited thereto.

In step S520, the processor 104 may determine a clickable object ratio (hereinafter referred to as N) of the currently used window based on a quantity of clickable window objects (hereinafter referred to as N_{c}) and the average clickable window object quantity. In an embodiment, the clickable object ratio (N) may be represented as “N=N_{c}/Nᵣ”, for example but may not be limited thereto.

In step S530, the processor 104 may obtain a quantity of visible texts (hereinafter referred to as O_{c}) in the currently used window, and obtain an average visible text quantity (hereinafter referred to as Oᵣ).

In an embodiment, the designer may collect quantities of other visible texts on other electronic devices in advance, and take the corresponding average value as the average visible text quantity (Oᵣ), but may not be limited thereto.

In step S540, the processor 104 may determine a text quantity ratio (hereinafter referred to as O) in the currently used window based on the quantity of visible texts (O_{c}) and the average visible text quantity (Oᵣ). In an embodiment, the text quantity ratio (O) may be represented as “O=O_{c}/Oᵣ”, but may not be limited thereto.

In step S550, the processor 104 may obtain a scroll thumb ratio (hereinafter referred to as R) between a scroll thumb and a scroll track in the window scrollbar. In an embodiment, for example, after obtaining an image region corresponding to the window scrollbar in the currently used window, the processor 104 may identify a first image area corresponding to the scroll thumb and a second image area corresponding to the scroll track (the scroll thumb may be dragged to slide in the scroll track) through existing image identification technology. After that, the processor 104 may take the ratio between the first image area and the second image area as the scroll thumb ratio (R), but may not be limited thereto.

In the embodiment of the disclosure, as the scroll thumb ratio (R) increases, it indicates an increasing area occupied by the scroll thumb in the window scrollbar, that is, a decreasing extent to which the currently used window can be scrolled. Comparatively, as the scroll thumb ratio (R) decreases, it indicates a decreasing area occupied by the scroll thumb in the window scrollbar, that is, an increasing extent to which the currently used window can be scrolled.

In step S560, the processor 104 may determine the clickable object ratio (N), the text quantity ratio (O), and the scroll thumb ratio (R) to be the statistical characteristics of each window object in the currently used window.

After determining the window characteristic (e.g., the currently used window ratio (I) and the window click rate (D)) of the currently used window and the statistical characteristic (e.g., the clickable object ratio (N), the text quantity ratio (O), and the scroll thumb ratio (R)) of each window object in the currently used window according to the contents of FIG. 4 and FIG. 5, the processor 104 may determine the second touch sensitivity adjustment coefficient (S_{g}) based on the system information, the window characteristic of the currently used window, and the statistical characteristic of each window object.

In an embodiment, the processor 104 may determine a screen resolution ratio (hereinafter referred to as C) of the currently used window based on the system information. In an embodiment, the screen resolution ratio (C) may be represented as “C=Max (C_{c}/Cᵣ, 1)”, where C_{c} is a resolution product of the electronic device 100, and Cᵣ is a reference resolution product.

In an embodiment, the designer may collect screen resolution products on other electronic devices in advance, and take the corresponding average value as the reference resolution product (Cᵣ), but may not be limited thereto.

For example, assuming that the resolution of the electronic device 100 is 3840*2160, the resolution product of the electronic device 100 is 8294400, for example. Assuming that each of the screen resolutions of other electronic devices collected by the designer is 1920*1080 as commonly seen, the reference resolution product (Cᵣ) is 273600, for example. In this case, the screen resolution ratio (C) may be calculated as 4, for example but may not be limited thereto.

After that, the processor 104 may determine the second touch sensitivity adjustment coefficient (S_{g}) based on the screen resolution ratio (C), the currently used window ratio (I), the window click rate (D), the clickable object ratio (N), the text quantity ratio (O), and the scroll thumb ratio (R).

In an embodiment, the second touch sensitivity adjustment coefficient (S_{g}) may be represented as:

S_{g}=(W_{C}*C+W_{I}*I+W_{N}*N⁻¹+W_{O}*O+W_{D}*D⁻¹+W_{R}*R)/(W_{C}+W_{I}+W_{N}+W_{O}+W_{D}+W_{R}) Formula (2)

where W_{c}, W_{I}, W_{N}, W_{O}, W_{D}, and W_{R} are a plurality of weights respectively corresponding to C, I, N, O, D, and R. As can be seen from Formula (2), the second touch sensitivity adjustment coefficient (S_{g}) is positively correlated with the screen resolution ratio (C) and the currently used window ratio (I), and negatively correlated with the window click rate (D), the clickable object ratio (N), the text quantity ratio (O), and the scroll thumb ratio (R), but may not be limited thereto.

With reference to FIG. 2 again, after determining the second touch sensitivity adjustment coefficient (S_{g}), in step S240, the processor 104 determines a specific touch sensitivity adjustment coefficient (hereinafter referred to as S) based on the first touch sensitivity adjustment coefficient (Sₗ) and the second touch sensitivity adjustment coefficient (S_{g}).

In an embodiment, the specific touch sensitivity adjustment coefficient (S) is represented as:

S=(W_{g}*S_{g}+Wₗ*Sₗ)/(W_{g}+Wₗ) Formula (3)

where W_{g} and Wₗ are a plurality of weights respectively corresponding to S_{g} and Sₗ. As can be seen from Formula (3), the specific touch sensitivity adjustment coefficient (S) is positively correlated with the first touch sensitivity adjustment coefficient (Sₗ) and the second touch sensitivity adjustment coefficient (S_{g}), but may not be limited thereto.

Based on this, as can be seen from Formula (1), Formula (2), and Formula (3) comprehensively, the specific touch sensitivity adjustment coefficient (S) is positively correlated with the control area ratio (B), the screen resolution ratio (C), and the currently used window ratio (I), and negatively correlated with the control click rate (P), the window click rate (D), the clickable object ratio (N), the text quantity ratio (O), and the scroll thumb ratio (R).

Next, in step S250, the processor 104 adjusts the current touch sensitivity (hereinafter referred to as Yᵢₙ) of the touchpad to specific touch sensitivity (hereinafter referred to as Yₒᵤₜ) based on the specific touch sensitivity adjustment coefficient (S).

In an embodiment, the specific touch sensitivity (Yₒᵤₜ) may be represented as:

Yₒᵤₜ=2*(Sigmoid(S/V)−Cₐ))*Yᵢₙ Formula (4)

where V is an adjustment coefficient corresponding to a Sigmoid function, and Cₐ is a displacement of a normalized gain.

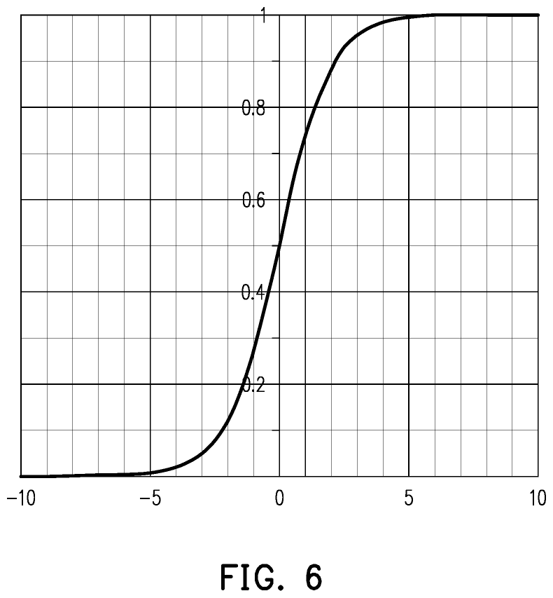

With reference to FIG. 6, FIG. 6 is a schematic diagram of a Sigmoid function according to an embodiment of the disclosure. As shown in FIG. 6, when the input value of the Sigmoid function is 0, the corresponding output value is 0.5. As a result, Cₐ may be set to 0.5 to cancel the output shift of the Sigmoid function, but may not be limited thereto.

In addition, as can be seen from characteristics of the Sigmoid function, when the input value is 5, the corresponding output value is saturated to 1; when the input value is −5, the corresponding output value is saturated to 0. Based on this, in an embodiment, V may be set to 0.2 (i.e., ⅕), but may not be limited thereto.

In another embodiment, the specific touch sensitivity (Yₒᵤₜ) may be represented as:

Yₒᵤₜ=(Yₘₐₓ−Yₘᵢₙ)*(Sigmoid(Yᵢₙ*S−Cₛ)/V))+Yₘᵢₙ Formula (5)

where Yₒᵤₜ is the specific touch sensitivity, Yᵢₙ is the current touch sensitivity, S is the specific touch sensitivity adjustment coefficient, V is an adjustment coefficient corresponding to the Sigmoid function, Cₛ is an input displacement of the Sigmoid function, Yₘₐₓ is a touch sensitivity upper limit, and Yₘᵢₙ is a touch sensitivity lower limit.

In an embodiment, assuming that the touch sensitivity of the touchpad may be adjusted within a specific range of 1 to 5, then Yₘᵢₙ and Yₘₐₓ are respectively 1 and 5, but may not be limited thereto.

In an embodiment, Cₛ may be represented as “Y_{mid}*Sₘ”, where Y_{mid} is the middle value of the specific range, for example 3, but may not be limited thereto. In an embodiment, after obtaining specific touch sensitivity adjustment coefficients corresponding to other electronic devices, the processor 104 may also take the average value as Sₘ, but may not be limited thereto.

In an embodiment, V may be expressed as “((Yₘₐₓ−Yₘᵢₙ)*4*S_{d})/10”. In this embodiment, after obtaining specific touch sensitivity adjustment coefficients corresponding to other electronic devices, the processor 104 may also take the standard deviation as Sa, but may not be limited thereto.

As can be seen from Formulae (4) and (5), the specific touch sensitivity (Yₒᵤₜ) is positively correlated with the specific touch sensitivity adjustment coefficient (S).

Based on this, as can be seen from Formula (1) to Formula (5) comprehensively, if the control area ratio (B), the screen resolution ratio (C), and the currently used window ratio (I) increase, the specific touch sensitivity adjustment coefficient (S) is increased, and the specific touch sensitivity (Yₒᵤₜ) is increased correspondingly.

In other words, the specific touch sensitivity adjustment coefficient (S) and the specific touch sensitivity (Yₒᵤₜ) are increased with an increase in the area of the specific control where the cursor is located, an increase in the screen resolution of the electronic device 100, and/or an increase in the size of the currently used window. In the embodiment of the disclosure, an increasing touch sensitivity of the touchpad speeds up the moving speed of the cursor. Accordingly, it is possible to prevent lagging or excessively slowing during movement of the cursor.

From another point of view, the specific touch sensitivity adjustment coefficient (S) and the specific touch sensitivity (Yₒᵤₜ) are reduced with a reduction in the area of the specific control where the cursor is located, a reduction in the screen resolution of the electronic device 100, and/or a reduction in the size of the currently used window. In the embodiment of the disclosure, a decreasing touch sensitivity of the touchpad slows down the moving speed of the cursor, so that a user can use the cursor to operate the currently used window relatively precisely.

In addition, as can be seen from Formula (1) to Formula (4) comprehensively, if the control click rate (P), the window click rate (D), the clickable object ratio (N), the text quantity ratio (O), and the scroll thumb ratio (R) increase, the specific touch sensitivity (Yₒᵤₜ) is reduced, and the specific touch sensitivity (Yₒᵤₜ) is reduced correspondingly.

In other words, the specific touch sensitivity adjustment coefficient (S) and the specific touch sensitivity (Yₒᵤₜ) are reduced with an increase in the click rate of the specific control where the cursor is located, an increase in the click rate of the currently used window, an increase in the clickable object ratio in the currently used window, an increase in the text quantity ratio in the currently used window, and/or an increase in the area occupied by the scroll thumb in the window scrollbar. Accordingly, the moving speed of the cursor is slowed down, so that a user can use the cursor to operate the currently used window relatively precisely.

From another point of view, the specific touch sensitivity adjustment coefficient (S) and the specific touch sensitivity (Yₒᵤₜ) are increased with a reduction in the click rate of the specific control where the cursor is located, a reduction in the click rate of the currently used window, a reduction in the clickable object ratio in the currently used window, a reduction in the text quantity ratio in the currently used window, and/or a reduction in the area occupied by the scroll thumb in the window scrollbar. Accordingly, it is possible to prevent lagging or excessively slowing during movement of the cursor.

In summary of the foregoing, in the method provided by the embodiment of the disclosure, touch sensitivity of a touchpad may be dynamically adjusted when the cursor moves on different windows and/or window objects (e.g., controls). Accordingly, the moving speed of the cursor can be relatively in line with the current use context, preventing difficulty in accurate interaction of a user with the currently used window due to excessively fast movement of the cursor, or an adversely affected use experience caused by excessively slowing/lagging movement of the cursor.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for dynamically adjusting sensitivity of a touchpad, the method being adapted to an electronic device including a touchpad, and the method comprising:
detecting system information of the electronic device;
determining a currently used window where a cursor stays in a user interface, obtaining a current use behavior of the currently used window, and accordingly determining a first touch sensitivity adjustment coefficient, wherein the currently used window comprises at least one window object;
obtaining a window characteristic of the currently used window and a statistical characteristic of each of the window object in the currently used window, and determining a second touch sensitivity adjustment coefficient based on the system information, the window characteristic of the currently used window, and the statistical characteristic of each of the window object;
determining a specific touch sensitivity adjustment coefficient based on the first touch sensitivity adjustment coefficient and the second touch sensitivity adjustment coefficient; and
adjusting current touch sensitivity of the touchpad to specific touch sensitivity based on the specific touch sensitivity adjustment coefficient.

2. The method according to claim 1, wherein the system information comprises at least one of a screen resolution, control information, a touch point position, and predetermined touchpad sensitivity.

3. The method according to claim 1, wherein the at least one window object comprises at least one control, and obtaining the current use behavior of the currently used window, and accordingly determining the first touch sensitivity adjustment coefficient comprises:
finding a specific control where the cursor stays among the at least one control, and a current control stay time for which the cursor stays on the specific control;
obtaining an average area of a plurality of other controls of the same type with the specific control;
determine a control area ratio based on a control area of the specific control and the average area;
obtaining a current click count of the specific control, and obtaining an average click count and an average stay time of the other controls;
determining a control click rate of the specific control based on the current click count, the current control stay time, the average click count, and the average stay time;
determining the first touch sensitivity adjustment coefficient based on the control area ratio and the control click rate.

4. The method according to claim 3, wherein the first touch sensitivity adjustment coefficient is represented as:
Sₗ=(W_{B}*B+W_{P}*P⁻¹)/(W_{B}+W_{P})
where Sₗ is the first touch sensitivity adjustment coefficient, B is the control area ratio, P is the control click rate, and W_{B} and W_{P} are respectively a plurality of weights corresponding to B and P.

5. The method according to claim 1, comprising:
obtaining a size of the currently used window and an average window size, and accordingly determining a currently used window ratio;
determining a current window click count of the cursor on the currently used window and a current window stay time for which the cursor stays on the currently used window, and accordingly determining a window click rate of the currently used window;
determining the currently used window ratio and the window click rate to be the window characteristics of the currently used window.

6. The method according to claim 1, wherein the window object in the currently used window comprises a plurality of visible texts and a window scrollbar, and the method comprises:
finding at least one clickable window object among the window object in the currently used window, and obtaining an average clickable window object quantity;
determining a clickable object ratio of the currently used window based on a quantity of the at least one clickable window object and the average clickable window object quantity;
obtaining a quantity of the visible texts in the currently used window, and obtaining an average visible text quantity;
determining a text quantity ratio in the currently used window based on the quantity of the visible texts and the average visible text quantity;
obtaining a scroll thumb ratio between a scroll thumb and a scroll track in the window scrollbar;
determining the clickable object ratio, the text quantity ratio, and the scroll thumb ratio to be the statistical characteristics of each of the window object in the currently used window.

7. The method according to claim 1, wherein the window characteristic of the currently used window comprises a currently used window ratio and a window click rate, the statistical characteristic of each of the window object in the currently used window comprises a clickable object ratio, a text quantity ratio, and a scroll thumb ratio, and determining the second touch sensitivity adjustment coefficient based on the system information, the window characteristic of the currently used window, and the statistical characteristic of each of the window object comprises:
determining a screen resolution ratio of the currently used window based on the system information;
determining the second touch sensitivity adjustment coefficient based on the screen resolution ratio, the currently used window ratio, the window click rate, the clickable object ratio, the text quantity ratio, and the scroll thumb ratio.

8. The method according to claim 7, wherein the screen resolution ratio is represented as:
C=Max(C_{c}/Cᵣ,1)
where C is the screen resolution ratio, C_{c} is a resolution product of the electronic device, and Cᵣ is a reference resolution product.

9. The method according to claim 7, wherein the second touch sensitivity adjustment coefficient is represented as:
S_{g}=(W_{C}*C+W_{I}*I+W_{N}*N⁻¹+W_{O}*O+W_{D}*D⁻¹+W_{R}*R)/(W_{C}+W_{I}+W_{N}+W_{O}+W_{D}+W_{R})
where S_{g} is the second touch sensitivity adjustment coefficient, C is the screen resolution ratio, I is the currently used window ratio, N is the clickable object ratio, O is the text quantity ratio, D is the window click rate, R is the scroll thumb ratio, and W_{c}, W_{I}, W_{N}, W_{O}, W_{D}, and W_{R} are a plurality of weights respectively corresponding to C, I, N, O, D, and R.

10. The method according to claim 1, wherein the specific touch sensitivity adjustment coefficient is represented as:
S=(W_{g}*S_{g}+Wₗ*Sₗ)/(W_{g}+Wₗ)
where S is the specific touch sensitivity adjustment coefficient, Si is the first touch sensitivity adjustment coefficient, S_{g} is the second touch sensitivity adjustment coefficient, and W_{g} and Wₗ are a plurality of weights respectively corresponding to S_{g} and Sₗ.

11. The method according to claim 1, wherein the specific touch sensitivity is represented as:
Yₒᵤₜ=2*(Sigmoid(S/V)−Cₐ))*Yᵢₙ
where Yₒᵤₜ is the specific touch sensitivity, Yᵢₙ the current touch sensitivity, S is the specific touch sensitivity adjustment coefficient, V is an adjustment coefficient corresponding to a Sigmoid function, and Cₐ is a displacement of a normalized gain.

12. The method according to claim 1, wherein the specific touch sensitivity is represented as:
Yₒᵤₜ=(Yₘₐₓ−Yₘᵢₙ)*(Sigmoid(Yᵢₙ*S−Cₛ)/V))+Yₘᵢₙ
where Yₒᵤₜ is the specific touch sensitivity, Yᵢₙ is the current touch sensitivity, S is the specific touch sensitivity adjustment coefficient, V is an adjustment coefficient corresponding to a Sigmoid function, Cₛ is an input displacement of the Sigmoid function, Yₘₐₓ is a touch sensitivity upper limit, and Yₘᵢₙ is a touch sensitivity lower limit.

13. An electronic device comprising:
a storage circuit storing a programming code;
a processor coupled to the storage circuit and accessing the programming code to:
detect a plurality of windows in a user interface, and obtain respective object properties of a plurality of window objects in each of the windows;
detect system information of the electronic device;
determine a currently used window where a cursor stays among the windows, obtain a current use behavior of the currently used window, and accordingly determine a first touch sensitivity adjustment coefficient;
obtain a window characteristic of the currently used window and a statistical characteristic of each of the window objects in the currently used window, and determine a second touch sensitivity adjustment coefficient based on the system information, the window characteristic of the currently used window, and the statistical characteristic of each of the window objects;
determine a specific touch sensitivity adjustment coefficient based on the first touch sensitivity adjustment coefficient and the second touch sensitivity adjustment coefficient; and
adjust current touch sensitivity of the electronic device to specific touch sensitivity based on the specific touch sensitivity adjustment coefficient.

14. The electronic device according to claim 13, wherein the at least one window object comprises at least one control, and the processor performs:
finding a specific control where the cursor stays among the at least one control, and a current control stay time for which the cursor stays on the specific control;
obtaining an average area of a plurality of other controls of the same type with the specific control;
determine a control area ratio based on a control area of the specific control and the average area;
obtaining a current click count of the specific control, and obtaining an average click count and an average stay time of the other controls;
determining a control click rate of the specific control based on the current click count, the current control stay time, the average click count, and the average stay time;
determining the first touch sensitivity adjustment coefficient based on the control area ratio and the control click rate;
wherein the first touch sensitivity adjustment coefficient is represented as:
Sₗ=(W_{B}*B+W_{P}*P⁻¹)/(W_{B}+W_{P})
where Sₗ is the first touch sensitivity adjustment coefficient, B is the control area ratio, P is the control click rate, and W_{B} and W_{P} are respectively a plurality of weights corresponding to B and P.

15. The electronic device according to claim 13, wherein the processor performs:
obtaining a size of the currently used window and an average window size, and accordingly determining a currently used window ratio;
determining a current window click count of the cursor on the currently used window and a current window stay time for which the cursor stays on the currently used window, and accordingly determining a window click rate of the currently used window;
determining the currently used window ratio and the window click rate to be the window characteristics of the currently used window.

16. The electronic device according to claim 13, wherein the window object in the currently used window comprises a plurality of visible texts and a window scrollbar, and the processor performs:
finding at least one clickable window object among the window object in the currently used window, and obtaining an average clickable window object quantity;
determining a clickable object ratio of the currently used window based on a quantity of the at least one clickable window object and the average clickable window object quantity;
obtaining a quantity of the visible texts in the currently used window, and obtaining an average visible text quantity;
determining a text quantity ratio in the currently used window based on the quantity of the visible texts and the average visible text quantity;
obtaining a scroll thumb ratio between a scroll thumb and a scroll track in the window scrollbar;
determining the clickable object ratio, the text quantity ratio, and the scroll thumb ratio to be the statistical characteristics of each of the window object in the currently used window.

17. The electronic device according to claim 13, wherein the window characteristic of the currently used window comprises a currently used window ratio and a window click rate, the statistical characteristic of each of the window object in the currently used window comprises a clickable object ratio, a text quantity ratio, and a scroll thumb ratio, and the processor performs:
determining a screen resolution ratio of the currently used window based on the system information;
determining the second touch sensitivity adjustment coefficient based on the screen resolution ratio, the currently used window ratio, the window click rate, the clickable object ratio, the text quantity ratio, and the scroll thumb ratio;
wherein the screen resolution ratio is represented as:
C=Max(C_{c}/Cᵣ,1)
where C is the screen resolution ratio, C_{c} is a resolution product of the electronic device, and Cᵣ is a reference resolution product.

18. The electronic device according to claim 17, wherein the second touch sensitivity adjustment coefficient is represented as:
S_{g}=(W_{C}*C+W_{I}*I+W_{N}*N⁻¹+W_{O}*O+W_{D}*D⁻¹+W_{R}*R)/(W_{C}+W_{I}+W_{N}+W_{O}+W_{D}+W_{R})
where S_{g} is the second touch sensitivity adjustment coefficient, C is the screen resolution ratio, I is the currently used window ratio, N is the clickable object ratio, O is the text quantity ratio, D is the window click rate, R is the scroll thumb ratio, and W_{c}, W_{I}, W_{N}, W_{O}, W_{D}, and W_{R} are a plurality of weights respectively corresponding to C, I, N, O, D, and R.

19. The electronic device according to claim 13, wherein the specific touch sensitivity adjustment coefficient is represented as:
S=(W_{g}*S_{g}+Wₗ*Sₗ)/(W_{g}+Wₗ)
where S is the specific touch sensitivity adjustment coefficient, Sₗ is the first touch sensitivity adjustment coefficient, S_{g} is the second touch sensitivity adjustment coefficient, and W_{g} and Wₗ are a plurality of weights respectively corresponding to S_{g} and Sₗ.

20. The electronic device according to claim 13, wherein the specific touch sensitivity is represented as:
Yₒᵤₜ=(Yₘₐₓ−Yₘᵢₙ)*(Sigmoid(Yᵢₙ*S−Cₛ)/V))+Yₘᵢₙ
where Yₒᵤₜ is the specific touch sensitivity, Yᵢₙ is the current touch sensitivity, S is the specific touch sensitivity adjustment coefficient, V is an adjustment coefficient corresponding to a Sigmoid function, Cₛ is an input displacement of the Sigmoid function, Yₘₐₓ is a touch sensitivity upper limit, and Yₘᵢₙ is a touch sensitivity lower limit.
